(19) United States
(12) Patent Application Publication
(10) Pub. No.: US 2003/0208567 A1
(43) Pub. Date: Nov. 6, 2003

(54) Configuration of network appliances via e-mail

(76) Inventor: Mark T. Gross, Portland, OR (US)

Correspondence Address: MARGER JOHNSON & McCOLLOM, P.C., 1030 S.W. Morrison Street, Portland, OR, 97205, US

(21) Appl. No.: 10/427,185

(22) Filed: Apr. 30, 2003

Related U.S. Application Data
(62) Division of application No. 09/650,950, filed on Aug. 29, 2000.

(51) Int. Cl. G06F 15/177

(52) U.S. Cl. 709/220

(57) ABSTRACT

A method for configuring a network appliance with instructions sent by e-mail. A mail recipient on the appliance, either a mail client or a mail server, receives an e-mail containing instructions. The appliance then configures itself according to the instructions. The instructions may be parsed into instructions at the appliance or the instructions may arrive in a command format that does not require parsing. The appliance may have a persistent network connection or may connect to the network occasionally.

This application is a divisional of prior application Ser. No. 09/650,950 filed Aug. 29, 2000.

### BACKGROUND

1. Field

This disclosure relates to network appliances, more particularly to methods and apparatuses for configuration of those appliances.

2. Background

Network appliances are becoming prevalent. Network appliances are also referred to as Internet appliances, Internet devices and networked devices. Generally, they are devices that can connect to a network, individually or through a computer, and download, browse or provide content to the network. Web cams, electronic books, browser phones, MP3 players and other types of devices would be considered network appliances in the above definition.

For purposes of discussion, and with no intention to limit application of the invention, network appliances will be categorized as data sources or data recipients. Data recipients are those devices that receive content from the network, not including control information. Data sources are those that provide content to the network, such as web cams.

These devices are typically configured when they are connected to the network. They may be reconnected or powered on or off remotely, but typically their configuration does not change. If the configuration is changed, it normally requires adjustment through direct interaction with the device, normally through a user interface. Alternatively, for those devices that can be configured over a network, they typically require some sort of interface that allows the person changing the configuration to be linked to that device to make the adjustments.

Either one of these approaches as well as others require a user interface to be resident on the device to allow configuration. Data sources and data recipients have user interfaces, although their functionality is slightly different. For example, a user interface for configuring a web camera may determine what content the web camera sends to the network. A network audio player, such as an MP3 player, may be configured with what content it retrieves from the network, such as a play list or list of Internet-broadcasting radio stations.

However, requiring configuration to occur at the device does not take advantage of the network with which the device communicates with other devices. Devices already on the network would be more useful and adaptable if they could be configured remotely. Some types of devices, such as routers and servers, may be configured remotely.

However, the configuration processes for these types of devices require detailed knowledge of the device being configured in order for the person performing the configuration to use the proper methods. In addition, the person performing the configuration may have system administrator or ‘superuser’ status in order to have the authorizations necessary to perform the configuration. This is not helpful to the average user.

### BRIEF DESCRIPTION OF THE DRAWINGS

The invention may be best understood by reading the detailed description with reference to the drawing(s), wherein:

FIG. 1 shows one embodiment of a network device in communication with a network, in accordance with the invention.

FIG. 2 shows another embodiment of a network device in communication with a network, in accordance with the invention.

FIG. 3 shows one embodiment of a method to remotely configure a network device, in accordance with the invention.

### DETAILED DESCRIPTION OF THE EMBODIMENTS

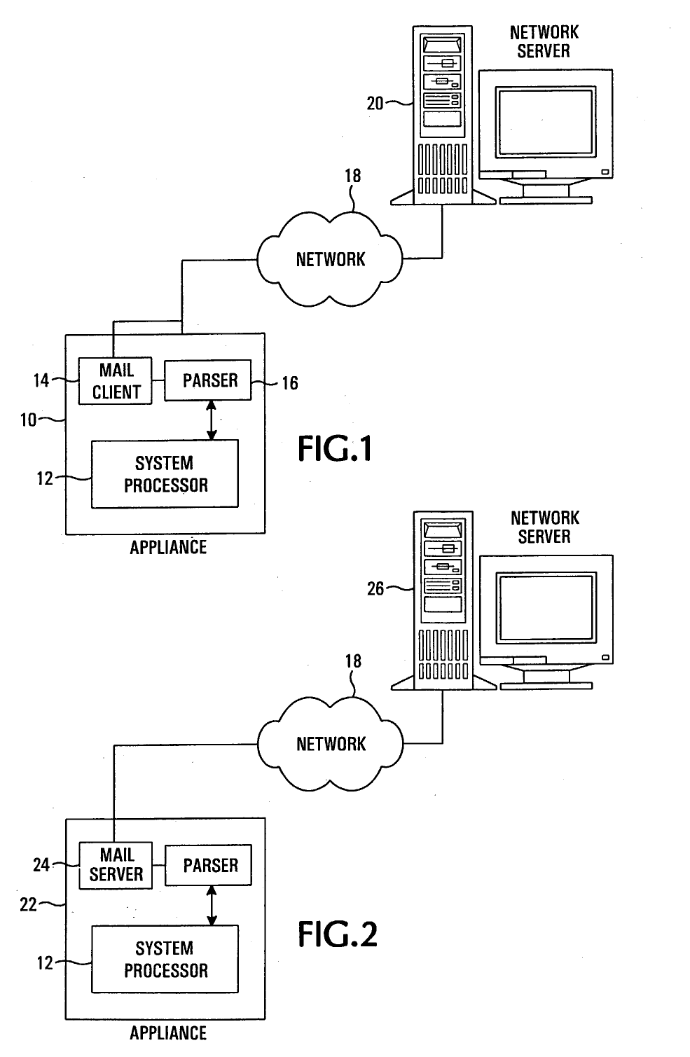

One embodiment of a network appliance in accordance with the invention is shown in FIG. 1. The network appliance 10 has a mail client 14 embedded within it. The mail client 14 maybe software installed in the system processor 12, or may be installed as part of a separate component. For ease of discussion, and with no intention of limiting application of the invention, the mail client 14 will be discussed as if it were separate.

The mail client is operable to receive e-mail containing configuration instructions. For convenience of the user, these instructions would be received as a text file. Alternatively, the instructions could be sent as a code module in whatever programming language the device is capable of interpreting, or as machine language. However, ease and convenience would indicate that the ability to send the instructions as a text file would be more useful to the average consumer. In this instance, the appliance 10 may include a parser 16 capable of extracting the required commands from a text file.

The parser may be a separate component or part of the system processor. It is only shown as a separate component for ease of discussion, with no intention of limiting application of the invention. However, this is an optional component for the appliance. The parsing may be done at the network server, or through an intermediate server.

In the example of FIG. 1, the appliance 10 would receive e-mail instructions from the mail server 20 through the network 18. The mail client 14 would operate to retrieve the e-mail messages from the mail server 20. The parser 16 would then extract the commands contained in any configuration e-mails and communicate with the system processor 12. The system processor 12 would then configure the appliance 10 accordingly.

Electronic mail (e-mail) servers can be configured within devices and on networks in several ways. A common method for handling e-mail is to have a network server 20, upon which is configured an e-mail server. In terms of the current embodiment of the Internet this is typically a Post-Office-Protocol, Version 3 server (POP3), an Internet Message Access Protocol (IMAP), or a Simple Mail Transfer Protocol (SMTP).

POP3 servers are typically configured in a client-server environment. A POP3 server resides on the network, communicating with other mail servers across the network 18. A client device, such as a personal computer with e-mail reader software installed, or a network appliance 10, in accordance with the invention, connects to the POP3 server. Once connected, the POP3 client downloads any e-mail for that client and may or may not disconnect.

This example may require an e-mail account to reside upon the mail server. E-mail from other servers across the network 18 send e-mail to the server on the network, which holds it in the client device account until the client device connects. Once communication is established between the client device and the server, the e-mail may be downloaded or otherwise accessed by the client device.

This example would typically occur for a device for which it is more convenient to only connect to the network occasionally. The device may be a portable device, such as an electronic book, or a device that may share a limited number of connections to the network. Connection could occur when the user happens to connect the device to the network, or could be on a timer or even basis, for those device that have constant connection capability if not actual access to a network connection.

An alternative embodiment is shown in FIG. 2. The network appliance 22 differs from that shown in FIG. 1 in that e-mail may not be handled on a client-server basis. A mail server 24, such as those discussed above, running SMTP, IMAP or any other variation on a mail server is embedded in the device 24. In the current embodiment of the Internet, such a server would work best with a persistent connection to the network. Otherwise, as other servers 26 on the network 18 send mail to the mail server on the device they would receive an error message if the device were not connected. In this example, there is no e-mail account that would hold incoming mail for the device until it makes connection. Therefore, the device would remain connected to receive its configuration instructions via e-mail.

As mentioned above, the parser 16 shown as part of the appliance 22 is an optional component. E-mails sent to the mail server on the device might be parsed into commands prior to arriving at the appliance. Alternatively, the sender may send them in command format, which the system processor 12 would identify with no parsing. Regardless of the format, the e-mails would include configuration instructions for the appliance and the system processor 12 would configure the device according to those instructions.

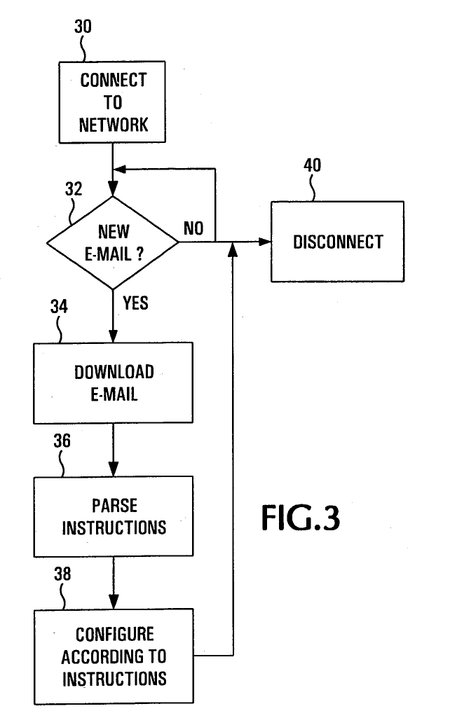

An embodiment of a method to configure a network appliance by e-mail is shown in FIG. 3. The appliance would connect to the network in 30, if necessary. This is an optional step, as the appliance may have a persistent network connection, wherein it is always connected to the network. The appliance would check for new e-mail at 32. If there is no new e-mail, and the appliance is one that connects to the network occasionally, it would disconnect at 40. If the appliance does remain connected to the network, it would return to monitoring for new e-mail, more than likely through a mail daemon.

If new e-mail were present, the e-mail would be downloaded or accessed by the mail recipient at 34. The term mail recipient as used here refers to either the mail client of FIG. 1 or the mail server of FIG. 2, as well as any future implementations of mechanisms for receiving e-mail. After downloading, the appliance may parse the instructions at 36, which is optional as discussed above. The appliance would then configure itself according to the configuration instructions at 38. The process would then return to monitoring for new e-mail, or possibly disconnect at 40.

The mail recipient may be installed on the network appliance by installation of program code into a network appliance. The program code would be contained on an article of storage medium, such as a floppy diskette, CD-ROM or downloadable from the memory of a computing device. The network appliance would act as a computing device and access the program code that executes all of the necessary instructions in the code to perform the methods set forth above.

An example of one application of the methods and apparatus of the invention could be a network appliance as a remote camera connected to a network, such as those know as web cameras or web cams. The configuration instruction to change the direction in which the camera points, or to order it to pan, tilt or zoom, would be sent in an e-mail across the network. The camera would access the e-mail and configure itself accordingly.

Another possible example is that of an Internet ‘radio’ receiver. The term ‘radio’ as used in these types of devices does not apply to broadcast signals being sent on the airwaves, as the term traditionally suggests. Instead, Internet radio refers to the format of the programs sent across the Internet as if they were broadcast stations, whether or not a substantially simultaneous traditional radio broadcast occurs. The configuration e-mail in this example may be a radio play list that switches the receiver to receive data from a URL from which different programs are being broadcast.

In these and several other examples, the use of e-mail to configure the device allows the average consumer to take advantage of the networked nature of these devices. The users can configure these devices in a convenient and relatively well-known way, making the appliances more useful.

Thus, although there has been described to this point a particular embodiment for a method and structure for an internet appliance configurable by e-mail, it is not intended that such specific references be considered as limitations upon the scope of this invention except in-so-far as set forth in the following claims.

What is claimed is:

1. A method for configuring an appliance across a network, comprising:
receiving configuration instructions via e-mail received at the appliance.

2. The method of claim 1 wherein the e-mail is received at a mail server on the appliance

3. The method of claim 2 wherein the mail server on the appliance communicates is one of the group comprised of: an IMAP server, and a SMTP server.

4. The method of claim 1 wherein the method further comprises running a mail daemon from the appliance, wherein the appliance is always connected to the network and the daemon monitors electronic mail for the device.

5. The method of claim 1 wherein the method further comprises connecting the appliance to the network to receive the electronic mail.

6. The method of claim 1 wherein the e-mail is received at a mail client on the appliance.

7. The method of claim 5 wherein the mail client on the appliance communicates with a mail server on the network.

8. A network appliance, comprising:
a connector operable to connect the appliance to a network; and
a mail recipient operable to receive electronic mail sent to the device.

9. The appliance of claim 8, wherein the appliance further comprises a parser operable to parse the electronic mail and extract configuration instructions from the electronic mail.

10. The appliance of claim 8, wherein the mail recipient is a mail server.

11. The appliance of claim 8, wherein the connector is operable to provide a persistent connection to the network.

12. The appliance of claim 8, wherein the mail recipient is a mail client.

13. The appliance of claim 8, wherein the connector is operable to connect the appliance to the network occasionally.

14. An article comprising:
A storage medium, the storage medium having stored thereon instructions, that, when executed by a computing device, result in:
i) reception of electronic mail by a network appliance; and
ii) configuration of the appliance in accordance with instructions contained in the electronic mail.

15. The article of claim 14, wherein the computing device is the network appliance.

16. The article of claim 15, wherein the network appliance is a remote camera.

17. The article of claim 15, wherein the network appliance is an Internet radio player.
